(19) United States
(12) Patent Application Publication
(10) Pub. No.: US 2023/0166953 A1
(43) Pub. Date: Jun. 1, 2023

(54) BATTERY TRANSFER DEVICE AND METHOD

(71) Applicant: BURNS & McDONNELL ENGINEERING COMPANY, KANSAS CITY, MO (US)

(72) Inventors: MATTHEW DOMEIER, KANSAS CITY, MO (US); JULIAN W. HOOVER, HOUSTON, TX (US)

(21) Appl. No.: 17/949,315

(22) Filed: Sep. 21, 2022

Related U.S. Application Data
(60) Provisional application No. 63/284,861, filed on Dec. 1, 2021.

(51) Int. Cl. B66D 1/60; B65G 39/12

(52) U.S. Cl. CPC B66D 1/60; B65G 39/12

(57) ABSTRACT

A battery transfer device having a base, a plurality of multidirectional rollers coupled to the base, and a winch coupled to the base. Each of the rollers is configured to rotate about at least a first axis and a second axis that is positioned at an angle with respect to the first axis. The winch has a cable or rope configured for coupling to a battery, and the winch is operable to pull the battery across the rollers. Guides may be removably coupled to the base adjacent one or both sides of the base. A method of using the battery transfer device to remove a battery from a battery rack or install a battery in a battery rack.

### CROSS-REFERENCE TO RELATED APPLICATIONS

This application is based on and claims priority to U.S. Provisional Application Ser. No. 63/284,861, filed on Dec. 1, 2021, which is incorporated herein by reference in its entirety.

### BACKGROUND OF THE INVENTION

A battery energy storage system (“BESS”) may be used to store electrical energy for later use. For example, a BESS may be connected to a power grid and used to supply electrical energy to the grid when an electric generator is offline. A BESS may include rows of battery racks with each rack having a number of slots for housing batteries that store electrical energy. Each battery may be relatively heavy (e.g., 100 to 300 pounds) and may be housed in a rack at a height of just above the ground to ten or more feet above the ground. A BESS may include hundreds or even thousands of batteries. It may be relatively difficult to install, remove, and/or replace a battery in a BESS due to the weight of the battery and the height at which it needs to be installed or removed. When multiple batteries in a BESS need to be installed or removed, the process may be relatively time-consuming and strenuous. Further, if batteries in a BESS are damaged, e.g., due to an overheating incident, it may be hazardous for a person to directly handle the batteries during the removal process.

### BRIEF SUMMARY OF THE INVENTION

The invention is directed toward a battery transfer device and a method of using the battery transfer device to either remove a battery from a battery rack or install a battery in a battery rack. The battery transfer device has a base, a plurality of multidirectional rollers coupled to the base, and a winch coupled to the base. Each of the rollers is configured to rotate about at least a first axis and a second axis that is positioned at an angle with respect to the first axis. The winch has a cable or rope configured for coupling to a battery, and the winch is operable to pull the battery across the rollers.

In some embodiments, the base may have a first end and a second end, and the winch may be operable to pull the battery across the rollers from the first end of the base toward the second end of the base. The base may have a first side extending between the first end and the second end. At least one guide may be removably coupled to the base adjacent the first side of the base. The guide may have a guide surface that is positioned above the rollers. The guide surface may be rotatable about a third axis that is generally perpendicular to an upper surface of the base. Further, there may be a first set of guides removably coupled to the base adjacent the first side of the base, and a second set of guides removably coupled to the base adjacent a second side of the base.

In some embodiments, the rollers may be configured to support the battery for movement across a plane that is positioned above and generally parallel to an upper surface of the base.

In some embodiments, each roller may be a ball mounted in a housing and operable to rotate in any direction with respect to the housing.

In some embodiments, the plurality of rollers may be configured so that a battery may be moved on the rollers in at least a first direction and a second direction that is perpendicular to the first direction.

In some embodiments, the winch may be an electric winch or a manual winch.

The battery transfer device may be used to remove a battery from a battery rack by positioning the base adjacent the battery in the battery rack, attaching the cable or rope of the winch to the battery, operating the winch to pull the battery out of the battery rack so that the battery is supported by at least one of the rollers, moving the battery with respect to the at least one roller so that the roller rotates about a first axis, and moving the battery with respect to the at least one roller so that the roller rotates about a second axis that is positioned at an angle with respect to the first axis. After the battery is supported by the rollers, the battery may be transferred from the battery transfer device to another support structure (e.g., a pallet) by removing the guide from the base, and moving the battery across the rollers toward the first side of the base. The battery may be moved over the edge of the first side until it is off of the battery transfer device and supported by the other support structure.

The battery transfer device may be used to install a battery in a battery rack by placing a battery on at least one of the rollers, positioning the base adjacent an open slot in a battery rack, and moving the battery with respect to the at least one roller until the battery is received by the open slot in the battery rack such that as the battery is moved the roller rotates about a first axis and the roller rotates about a second axis that is positioned at an angle with respect to the first axis.

### BRIEF DESCRIPTION OF THE DRAWINGS

Various exemplary embodiments of the present invention are described in detail below with reference to the attached drawing figures, wherein:

FIG. 1 is a perspective view of a battery transfer device in accordance with an embodiment of the invention described herein;

FIG. 2 is another perspective view of the battery transfer device shown in FIG. 1;

FIG. 3 is a top plan view of a base of the battery transfer device shown in FIG. 1;

FIG. 4 is a perspective view of a roller assembly of the battery transfer device shown in FIG. 1;

FIG. 5 is a perspective view of a plurality of battery racks;

FIGS. 6-7 are perspective views showing a plurality of batteries mounted in one of the battery racks shown in FIG. 5; and

FIG. 8 is a perspective view of a lift for use to move, raise, and lower the battery transfer device shown in FIG. 1.

### DETAILED DESCRIPTION OF EXEMPLARY EMBODIMENT

The present invention is directed to a battery transfer device, a method for removing a battery from a battery rack using the battery transfer device, and a method for installing a battery in a battery rack using the battery transfer device. While the present invention will be described in detail below with reference to various exemplary embodiments, it should be understood that the invention is not limited to the specific configurations of these embodiments. In addition, although the exemplary embodiments are described as embodying several different inventive features, one skilled in the art will appreciate that any one of these features could be implemented without the others in accordance with the present invention.

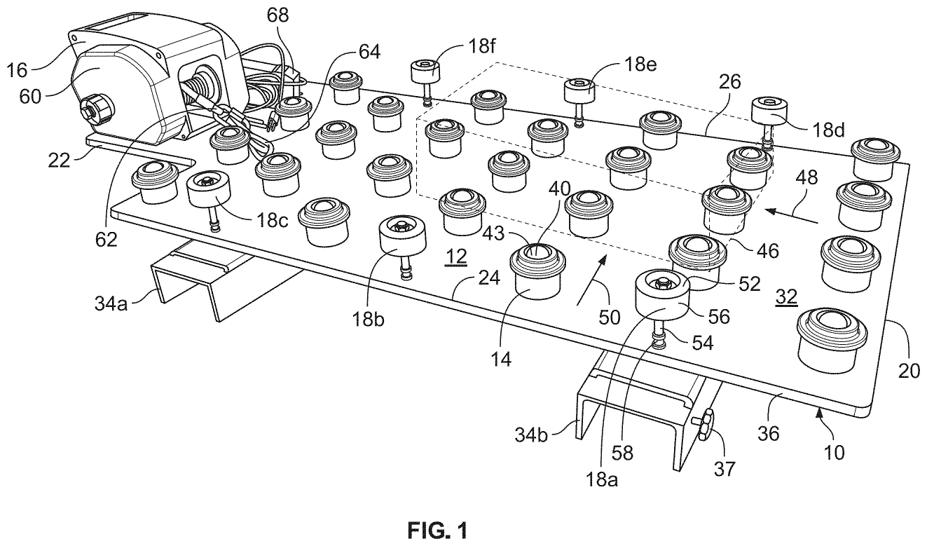

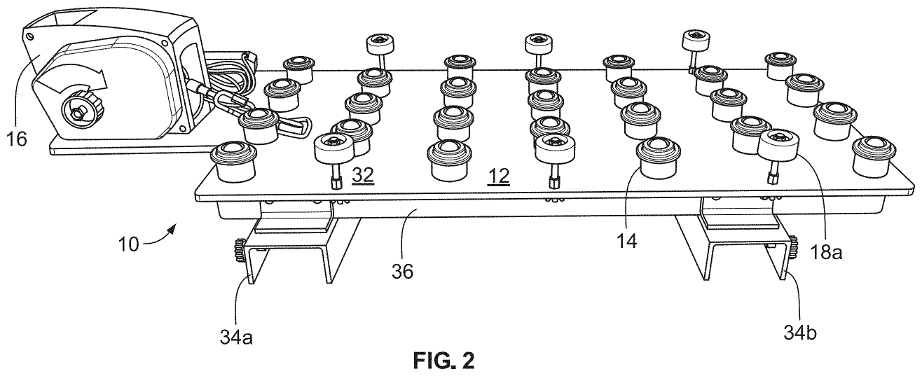

A battery transfer device in accordance with an embodiment of the invention described herein is identified generally with the reference numeral 10 in FIGS. 1 and 2. As described in more detail below, the battery transfer device 10 is operable to remove batteries from a battery rack, and install batteries in a battery rack, in a safe and efficient manner. For example, the battery transfer device 10 may be used to remove a damaged battery from a battery rack in a manner that an operator does not need to directly handle or touch the damaged battery during the removal process.

The battery transfer device 10 includes a base 12, a plurality of roller assemblies, one of which is identified in FIGS. 1-2 as 14, mounted to the base 12, a winch 16 mounted to the base 12, and a plurality of guides 18a-f mounted to the base 12.

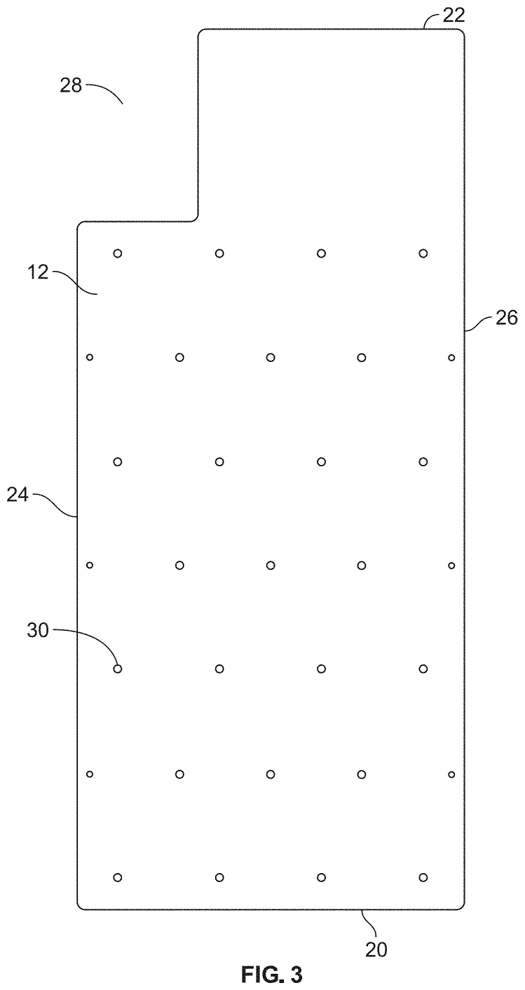

Referring to FIG. 3, the base 12 has a first end 20, a second end 22, a first side 24, and a second side 26. The first and second sides 24, 26 each extend between the first and second ends 20, 22. The base 12 is generally rectangular with a notch 28 at a corner adjacent the second end 22. The notch 28 may provide clearance when operating a lift with the base 12 on the lift, as described in more detail below. A plurality of openings, one of which is identified as 30, extend through the base 12. The openings 30 are arranged in seven rows each extending between the first side 24 and the second side 26 and each generally parallel to the first end 20. The roller assemblies 14 and guides 18a-f are mounted to the base 12 at the openings 30, as described in more detail below. As shown in FIGS. 1-2, the roller assemblies 14 and guides 18a-f extend upward from an upper surface 32 of the base 12. Two channels 34a-b are mounted to and extend downward from a lower surface 36 of the base 12. As described below, the channels 34a-b may be used to mount the base 12 to a lift. The base 12 may be configured with other means for mounting it to a lift other than channels 34a-b, or the base 12 may be formed as an integral part of a lift. A plastic hand knob screw 37 engages a threaded opening in the side of the channel 34b and extends into the void space defined by the channel 34b. The knob screw 37 may be used to secure the base 12 to a portion of a lift received by the channel 34b. The channel 34a may have a similar knob screw (not shown). The base 12 may be formed from aluminum or any other suitable material.

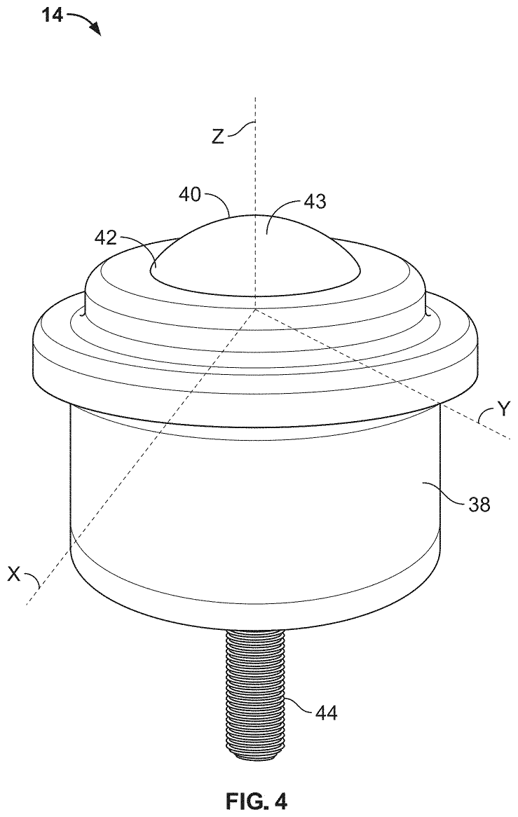

Referring to FIG. 4, the roller assembly 14 is a threaded stud mount ball transfer. The roller assembly 14 includes a housing 38 and a roller or ball 40 mounted in the housing 38 so that a portion of the ball 40 protrudes from an upper opening 42 of the housing 38. Bearings (not shown) positioned within the housing 38 support the ball 40 in the housing 38 and allow the ball 40 to rotate about any axis extending through the center of the ball 40. For example, the ball 40 may rotate about any of the X, Y, or Z axes shown in FIG. 4, or any other axis that is positioned at an angle with respect to the X, Y, or Z axes. The ball 40 has an uppermost portion 43 positioned above the housing 38. Since the ball 40 can rotate in any direction with respect to the housing 38, any portion of the ball 40 may be the uppermost portion 43 at any given time. The general location of the uppermost portion 43 relative to the base 12 does not significantly change no matter which portion of the ball 40 is the uppermost portion 43 at any given time. A threaded stud 44 extends downward from the housing 38. The threaded stud 44 is received by the opening 30 shown in FIG. 3, and a nut (not shown) threaded on the stud 44 adjacent the lower surface 36 of the base 12 secures the roller assembly 14 to the base 12.

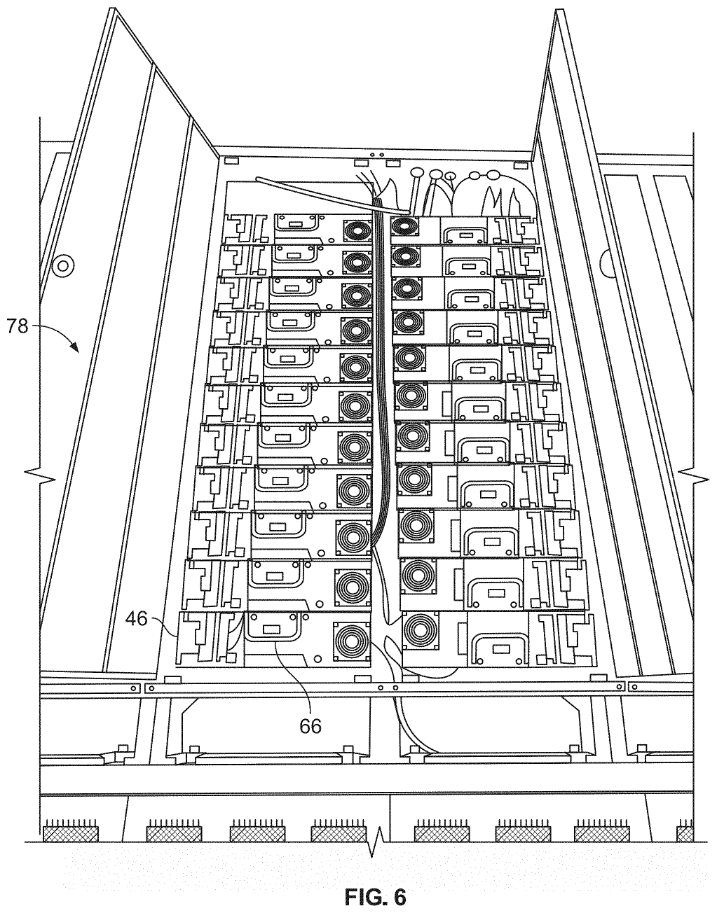

All of the roller assemblies 14 shown in FIGS. 1-2 have a similar construction as the roller assembly shown in FIG. 4 and described above. The uppermost portions 43 of all the balls 40 of all the roller assemblies 14 in combination define a plane that is positioned above and generally parallel to the upper surface 32 of the base 12. The balls 40 of all the roller assemblies 14 in combination are configured to support a battery, such as the battery 46 shown in FIGS. 1 and 6, and allow the battery to move in any direction across this plane defined by the uppermost portions 43 of the balls 40. For example, the battery 46 may move in a first direction 48, shown in FIG. 1, and a second direction 50 that is generally perpendicular to the first direction 48. The first direction 48 is generally parallel to the sides 24, 26 of the base 12, and the second direction 50 is generally parallel to the ends 20, 22 of the base 12. Since the balls 40 can rotate in any direction while the battery 46 is supported by the balls 40, the battery 46 can move in any direction across the plane defined by the uppermost portions 43 of the balls 40, and the battery 46 may be rotated about a vertical axis that is perpendicular to the base 12.

While the roller assemblies 14 described above and shown in FIGS. 1-2 and 4 are ball transfers, other types of multidirectional rollers that are configured to rotate about at least a first axis and a second axis that is positioned at an angle with respect to the first axis are within the scope of the invention. For example, any type of roller that allows a battery 46 to be moved across the roller in the first direction 48 and in the second direction 50 is within the scope of the invention. The multidirectional roller may also be a multidirectional or omnidirectional wheel or a portion of a multidirectional or omnidirectional wheel. For example, as a multidirectional or omindirectional wheel, the multidirectional roller may include a hub that rotates about a first axis and one or more rollers or rotating elements mounted to the hub and rotatable about an axis or axes that are positioned at an angle with respect to the first axis.

Referring to FIG. 1, the battery transfer device 10 includes a first set of guides 18a-c that are mounted to the base 12 adjacent the first side 24 of the base 12 and a second set of guides 18d-f that are mounted to the base 12 adjacent the second side 26 of the base 12. Each of the guides 18a-f is substantially similar. Accordingly, only guide 18a is described in detail herein. As shown in FIG. 1, guide 18a includes a wheel 52 that is rotatably mounted to base 12 with a bolt 54. The wheel 52 has an outer guide surface 56. The guide surface 56 is positioned above the base 12 and above the uppermost portions 43 of the balls 40. In this manner, a battery 46 supported by the balls 40 may be guided by the guide surface 56 to prevent the battery 46 from falling off the base 12. In other words, the guide surface 56 may contact the battery 46 to retain the battery 46 on the base 12 as the battery 46 is moved across the balls 40. The wheel 52 and guide surface 56 are rotatable about a vertical axis aligned with the bolt 54. Thus, if the battery 46 makes contact with the guide surface 56 as the battery 46 moves across the balls 40, the guide surface 56 may rotate as the battery 46 moves. The bolt 54 is threaded into a nut 58 that is mounted on the upper surface 32 of the base 12. The guide 18a may be removed from attachment to the base 12 by rotating the bolt 54 until it no longer engages the nut 58. Once the battery 46 is positioned in the center of the base 12, a user may remove one or more of the guides 18a-f to allow the user to push the battery 46 off one of the sides 24 or 26 of the base 12. For example, a pallet (not shown) may be positioned adjacent a side 24 or 26 of the base 12, and the battery 46 may be pushed on the pallet.

The winch 16 is mounted to the upper surface 32 of the base 12 at the second end 22 of the base 12. The winch 16 is a conventional electric winch with a housing 60 containing a motor (not shown) and a spool (not shown) around which a cable 62 is wound. The winch 16 is operable in one direction to unwind the cable 62 from the spool and an opposite direction to wind the cable 62 around the spool. A carabiner 64 is attached to the end of the cable 62. The carabiner 64 may be attached to a portion of the battery 46. For example, the carabiner 64 may be attached to the handle 66 shown in FIG. 6. When the cable 62 is extended so that the carabiner 64 is adjacent the first end 20 and the carabiner 64 is attached to a battery 46, the winch 16 is operable to pull the battery 46 across the balls 40 in the first direction 48 from the first end 20 of the base 12 toward the second end 22 of the base 12. The winch 16 may have a DC motor wired to an AC-DC transformer 68. The winch 16 may prevent injury and user strain, particularly when a heavy battery is pulled across the balls 40 and/or when the battery being moved is positioned relatively high above the ground.

Although winch 16 is shown as an electric winch, it is also within the scope of the invention for winch 16 to be a manual winch with a handle that is rotated by a user to extend or retract the cable 62 from the housing 60. Further, the cable 62 of winch 16 may be any type of rope or other elongate material capable for use with the winch 16 to pull the battery 46 across the balls 40. Broadly, the winch 16 may be any device operable to pull the battery 46 across the balls 40. Further, other devices other than a carabiner may be used to attach the cable 62 to a battery.

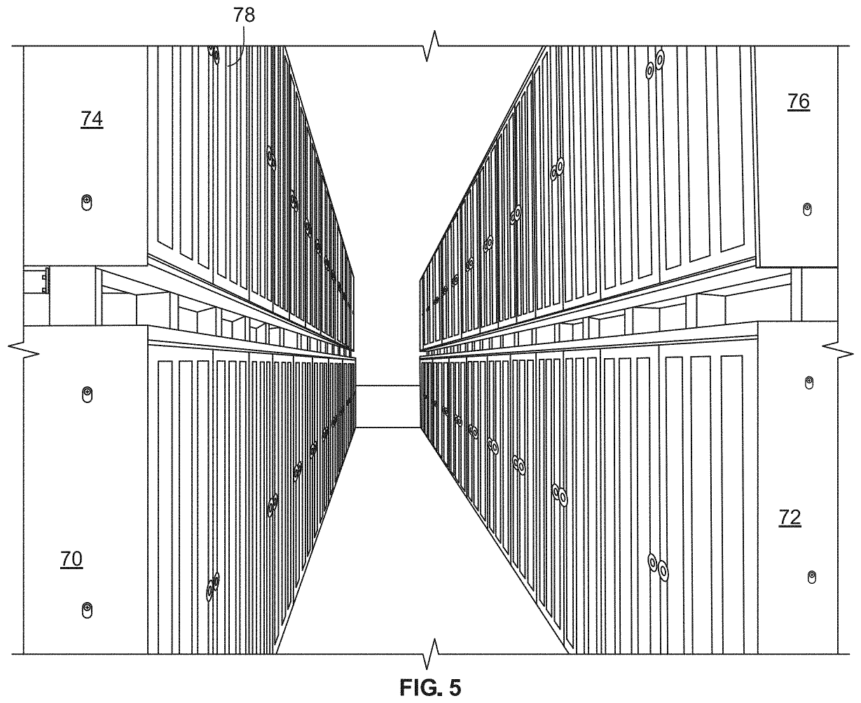

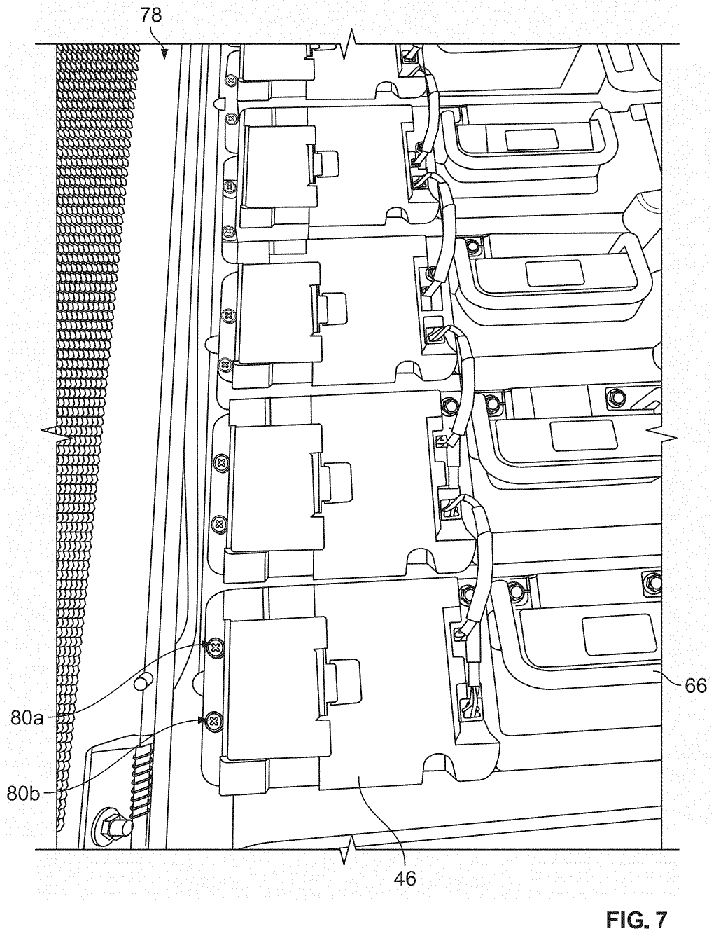

In operation, the battery transfer device 10 may be used to remove a battery from a battery rack. For example, FIG. 5 shows lower rows 70, 72 of battery racks and upper rows 74, 76 of battery racks mounted on the lower rows 70, 72, respectively. One of the battery racks is identified as 78 in FIG. 5 and shown in more detail in FIG. 6. The battery rack 78 includes doors that open to expose a plurality of batteries, one of which is identified as 46, arranged in slots in the battery rack 78. As shown in FIG. 7, the battery 46 may be mounted to the battery rack 78 with screws 80a,b on one side of the battery 46 and additional screws (not shown) on the other side of the battery 46. As described above, the battery 46 has a handle 66 that may be grasped to pull the battery 46 out of the battery rack 78 after the screws 80a,b are removed.

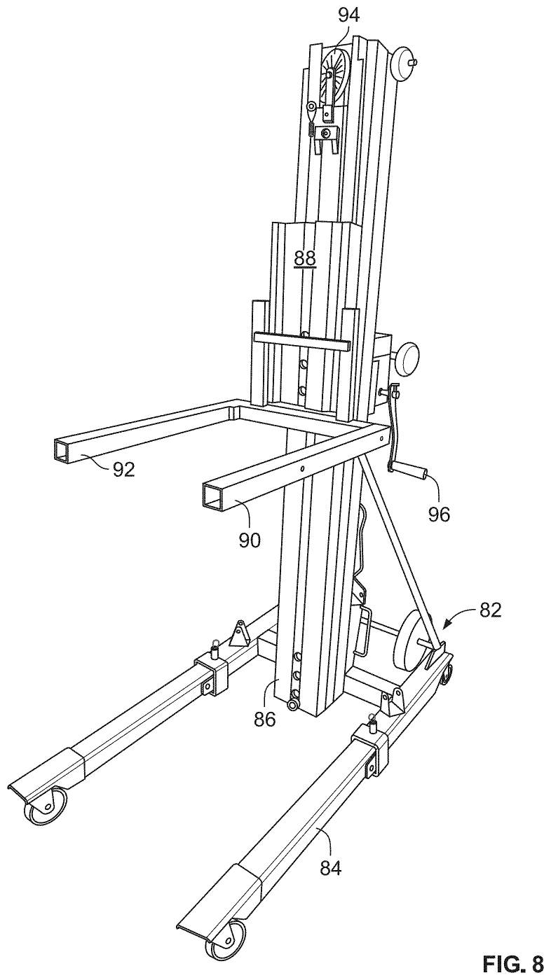

To remove the battery 46 with the battery transfer device 10, the battery transfer device 10 is first placed on a lift, such as the lift 82 shown in FIG. 8. The lift 82 generally has a wheeled base 84, a tower 86 extending upward from the base 84, and a carriage 88 that is vertically movable on the tower 86. Forks 90, 92 extend outward from the carriage 88. The carriage 88 may be movable up and down the tower 86 with a pulley system 94 and hand crank 96.

To place the battery transfer device 10 on the lift 82, the channels 34a,b of base 12 are placed over the forks 90, 92, respectively, to support the battery transfer device 10 on the carriage 88. The lift 82 is moved into position adjacent the battery rack 78 shown in FIGS. 5 and 6. The lift 82 is moved into position such that the first end 20 of the base 12 faces the battery 46 and is generally parallel to the front surface of the battery 46. The hand crank 96 is rotated to move the carriage 88 and battery transfer device 10 upward until the battery transfer device 10 is adjacent the battery 46 with the uppermost portion 43 of the balls 40 positioned at or just below a lower surface of the battery 46.

The screws 80a,b are then removed. The winch 16 is operated to extend the cable 62 outward toward the first end 20 of the base 12 until the carabiner 64 may be attached to the handle 66 of the battery 46. The carabiner 64 is then attached to the battery 46. The winch 16 is then operated in a reverse direction to pull the cable 62 and battery 46 toward the second end 22 of the base 12. As the winch 16 is operated, the battery 46 is pulled out of its slot in the battery rack 78 until it is supported by the balls 40 of the battery transfer device 10. The balls 40 rotate as the winch 16 pulls the battery 46 from the first end 20 toward the second end 22. Rotation of the balls 40 allows the battery 46 to smoothly slide on the battery transfer device 10 as it is pulled from the battery rack 78.

When the battery 46 is removed from the battery rack 78 and solely supported by the battery transfer device 10, the lift 82 may be operated to lower the carriage 88, battery transfer device 10, and battery 46. The lift 82 may then be wheeled to a location for transfer of the battery 46 to, for example, a pallet (not shown), which may hold the battery 46 as it is transported to a different location for disposal or recycling. To transfer the battery 46 from the battery transfer device 10 to a pallet, the lift 82 may be moved until it is adjacent a pallet. For example, the lift 82 may be moved adjacent a pallet so that the forks 90 and 92 of the lift 82 face the pallet and the second side 26 of the base 12 faces the pallet.

The guides 18d-f of the battery transfer device 10 may then be removed from engagement with the base 12, as described above. With the guides 18d-f removed, the battery 46 can be moved over the balls 40 toward and over the second side 26 of the base 12 until the battery 46 is positioned on the pallet. If multiple batteries in the battery rack 78 need to be removed, the lift 82 may be wheeled back to the battery rack 78 and used to remove additional batteries.

Further, the lift 82 and battery transfer device 10 may be used to place or install new batteries in the battery rack 78. When placing a new battery in the battery rack 78, the battery may be placed on the balls 40 of the battery transfer device 10 and the lift 82 may be operated generally as described above to position the new battery so that it is adjacent an open slot of the battery rack 78. A user may then push the new battery off the base 12 and in the open slot of the battery rack 78. As the battery is pushed across the balls 40 and off the base 12, the balls 40 may rotate about a first axis and a second axis that is positioned at an angle with respect to the first axis. The winch 16 may not be necessary when using the battery transfer device 10 to install a new battery in the battery rack 78.

Batteries removed by the battery transfer device 10 may weigh, for example, in the range of 100 to 300 pounds. Further, the batteries may be positioned in a battery rack at a height of, for example, between just above the ground to 8 or 10 or more feet above the ground. Use of the lift 82 and battery transfer device 10 to remove relatively heavy batteries at relatively high heights from a battery rack may cause less worker strain and be safer and easier than alternative methods of removing batteries from a battery rack. Use of the battery transfer device 10 may further reduce or eliminate the need for a worker to touch or directly handle a battery, which may be desirable if the battery is damaged and there is a risk that touching the damaged battery will harm the worker.

While a particular type of battery rack 78 is shown in FIGS. 5-7, the battery transfer device may be used to remove batteries from or install batteries in any type of battery rack. For example, the battery rack may be any structure that is used to support, hold, retain, or store one or more batteries. Further, while lift 82 is described above and shown in FIG. 8 as a manual lift, powered lifts may also be used to raise and lower the battery transfer device 10, e.g., compressed natural gas, liquid propane, gasoline, diesel, or electric lifts may be used.

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as”) provided with respect to certain embodiments is intended merely to better describe the invention and does not pose a limitation on the scope of the invention. No language in the description should be construed as indicating any non-claimed element essential to the practice of the invention.

The use of relative relational terms, such as first and second, top and bottom, and left and right, are used solely to distinguish one unit or action from another unit or action without necessarily requiring or implying any actual such relationship or order between such units or actions.

In addition, the recitation of ranges of values in this disclosure is merely intended to serve as a shorthand method of referring individually to each separate value falling within the range. Unless otherwise indicated, each individual value is incorporated into the disclosure as if it were individually recited herein.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

While the present invention has been described and illustrated hereinabove with reference to several exemplary embodiments, it should be understood that various modifications could be made to these embodiments without departing from the scope of the invention. Therefore, the present invention is not to be limited to the specific configurations or methodologies of the exemplary embodiments, except insofar as such limitations are included in the following claims.

What is claimed and desired to be secured by Letters Patent is as follows:

1. A battery transfer device comprising:
a base;
a plurality of multidirectional rollers coupled to the base, each of the rollers being configured to rotate about at least a first axis and a second axis that is positioned at an angle with respect to the first axis; and
a winch coupled to the base, the winch comprising a cable or rope configured for coupling to a battery, and the winch being operable to pull the battery across the rollers.

2. The battery transfer device of claim 1, wherein the base comprises a first end and a second end, and wherein the winch is operable to pull the battery across the rollers from the first end of the base toward the second end of the base.

3. The battery transfer device of claim 2, wherein the base comprises a first side extending between the first end and the second end, and further comprising at least one guide removably coupled to the base adjacent the first side of the base.

4. The battery transfer device of claim 3, wherein the guide comprises a guide surface that is positioned above the rollers.

5. The battery transfer device of claim 4, wherein the guide surface is rotatable about a third axis that is generally perpendicular to an upper surface of the base.

6. The battery transfer device of claim 2, wherein the base comprises a first side and a second side each extending between the first end and the second end, and further comprising a first set of guides removably coupled to the base adjacent the first side of the base, and a second set of guides removably coupled to the base adjacent the second side of the base.

7. The battery transfer device of claim 2, wherein the winch is coupled to the base adjacent the second end.

8. The battery transfer device of claim 1, wherein the rollers are configured to support the battery for movement across a plane that is positioned above and generally parallel to an upper surface of the base.

9. The battery transfer device of claim 1, wherein each roller comprises a ball mounted in a housing and operable to rotate in any direction with respect to the housing.

10. The battery transfer device of claim 1, wherein the plurality of rollers are configured so that a battery may be moved on the rollers in at least a first direction and a second direction that is perpendicular to the first direction.

11. The battery transfer device of claim 1, wherein the winch is an electric winch.

12. A method of removing a battery from a battery rack using a battery transfer device comprising a base, a plurality of multidirectional rollers coupled to the base, and a winch coupled to the base, the method comprising:
positioning the base adjacent a battery in a battery rack;
attaching a cable or rope of the winch to the battery;
operating the winch to pull the battery out of the battery rack so that the battery is supported by at least one of the rollers;
moving the battery with respect to the at least one roller so that the roller rotates about a first axis; and
moving the battery with respect to the at least one roller so that the roller rotates about a second axis that is positioned at an angle with respect to the first axis.

13. The method of claim 12, wherein the base of the battery transfer device comprises a first end and a second end, and wherein the winch pulls the battery across the rollers from the first end of the base toward the second end of the base.

14. The method of claim 13, wherein the base of the battery transfer device comprises a first side extending between the first end and the second end, and wherein the battery transfer device further comprises at least one guide removably coupled to the base adjacent the first side of the base.

15. The method of claim 14, further comprising removing the guide from the base after the battery is supported by at least one of the rollers, and moving the battery across the rollers toward the first side of the base.

16. The method of claim 12, wherein the winch is an electric winch.

17. The method of claim 12, wherein each roller comprises a ball that is mounted in a housing and operable to rotate in any direction with respect to the housing.

18. A method of installing a battery in a battery rack using a battery transfer device comprising a base and a plurality of multidirectional rollers coupled to the base, the method comprising:
placing a battery on at least one of the rollers;
positioning the base adjacent an open slot in a battery rack; and
moving the battery with respect to the at least one roller until the battery is received by the open slot in the battery rack such that as the battery is moved the roller rotates about a first axis and the roller rotates about a second axis that is positioned at an angle with respect to the first axis.
